(19) United States
(12) Patent Application Publication
(10) Pub. No.: US 2004/0122963 A1
(43) Pub. Date: Jun. 24, 2004

(54) System and method for implementing an asynchronous sockets interface

(76) Inventor: Dan Krejsa, Alameda, CA (US)

Correspondence Address: Fay Kaplun & Marcin, LLP, Suite 702, 150 Broadway, New York, NY, 10038, US

(21) Appl. No.: 10/326,639

(22) Filed: Dec. 19, 2002

(51) Int. Cl. G06F 15/16

(52) U.S. Cl. 709/230

(57) ABSTRACT

A socket object, comprising application specific information configured to allow interaction with an application and a core object having data for a specific class corresponding to the socket object, the data including a pointer to a set of functions corresponding to the class, wherein a protocol is limited to knowledge of the core object and uses the set of functions to obtain access to the application specific information.

### BACKGROUND INFORMATION

A computer network is simply a group of two or more computer or computing devices that are linked together. A personal computer (“PC”) or server is generally regarded as a traditional computing device, but other computing devices such as embedded devices (e.g., personal digital assistants (“PDAs”), mobile phones, routers, switches, etc.) may also be included as part of a computer network. Many types of networks exist, but the most common types of networks are Local-Area Networks (LANs) and Wide-Area Networks (WANs). In a LAN, the computing devices are connected within a “local” area, for example, a home or office. A LAN generally connects less than 100 network nodes. In a WAN, the interconnected computers are generally farther apart and are connected via telephone/communication lines, radio waves, or other means of communication. A Metropolitan Area Network (“MAN”) may include hundreds or even thousands of interconnected computing devices. There are also other network devices, for example, bridges, routers and switches, which may be used to link different networks or network segments into a larger network with more resources.

The information transferred between network devices is generally referred to as data packets (or simply as packets) and this transfer of information is generally referred to as packet flow. In response to the need for the different devices to communicate, standards bodies and other entities have developed numerous protocols for data packet flow over a network. A protocol specifies a common set of rules for packet format and packet flow, allowing a variety of devices to communicate.

On a computer network, sockets serve as endpoints for exchanging data between computing devices. Each socket has a socket address, which is a port number plus a network address. Applications desiring to communicate over a computer network generally make use of an Application Programming Interface (“API”) which provides the software services necessary for such communication. The most common interface is the Sockets API, often referred to as “Berkeley Sockets” as it was initially provided in the Berkeley Software Distribution (“BSD”) operating systems, but which has since been adopted (sometimes in slightly modified form) for use with many other computer operating systems. Most such operating systems provide a software layer implementing the Sockets API, intermediate between applications and the protocol layers of the network stack. These protocol layers implement standard network protocols such as the Transmission Control Protocol (“TCP”) and the Internet Protocol (“IP”), but their implementation is typically operating system dependent. The Sockets layer of the network stack provides services not only to the application programs above it, but also to the protocols (and lower stack levels) below it. The services provided to the lower levels of the stack typically include management of endpoint transmit and receive data buffers, of queues of newly arrived network connections, and of other endpoint control and state information, as well as the mechanisms for informing threads or processes of network endpoint events. A software layer which provides these services to the protocol and lower levels of the network stack may be considered a “Sockets layer” even if the interface which it provides to application layers above it is substantially different from the Berkeley Sockets API.

### SUMMARY OF THE INVENTION

A socket object, comprising application specific information configured to allow interaction with an application and a core object having data for a specific class corresponding to the socket object, the data including a pointer to a set of functions corresponding to the class, wherein a protocol is limited to knowledge of the core object and uses the set of functions to obtain access to the application specific information.

A system, comprising an application, a protocol to communicate data over a computer network and a sockets layer providing an endpoint service to the application and the protocol, the sockets layer including an endpoint class, the sockets layer configured to create an endpoint to provide the endpoint service, the endpoint including a pointer to a set of functions corresponding to the endpoint class and information corresponding to the application.

Furthermore, a method, comprising the steps of receiving data at a protocol, accessing a function corresponding to an endpoint, the function causing the data to be passed to a receive buffer of the endpoint, copying the data to a kernel buffer for the endpoint and freeing the receive buffer of the endpoint.

### BRIEF DESCRIPTION OF DRAWINGS

FIG. 1 shows an exemplary data structure for an ASI socket and an exemplary table including ASI socket functions according to the present invention;

FIG. 2 shows an exemplary system 100 implementing the ASI sockets according to the present invention;

FIG. 3 shows an exemplary process for creating an ASI socket according to the present invention;

FIG. 4 shows an exemplary process for connection an ASI socket according to the present invention.

### DETAILED DESCRIPTION

The present invention may be further understood with reference to the following description and the appended drawings, wherein like elements are provided with the same reference numerals. The exemplary embodiment may be described as being implemented on a computing device and this should be understood to mean any computing and/or electronic device including a processor and/or microprocessor, for example, PCs, servers, internet devices, embedded devices, or any computing device, and the term device will be used to generally describe such devices. In addition, the exemplary embodiment of the present invention is described with reference to a device having a main processor and a secondary processor (sometimes referred to as an I/O processor). Those of skill in the art will understand that this type of device is only exemplary an that the present invention may be implemented on any type of computing device, regardless of whether the computing device has an I/O processor. Furthermore, throughout this specification the terms socket, endpoint, ASI socket and ASI socket object may be used interchangeably to describe an exemplary implementation of the present invention and these terms should be understood to refer to such exemplary implementations.

The exemplary embodiment of the present invention provides an asynchronous sockets interface (“ASI”) which may be used to replace a normal sockets layer (e.g., sockets layer used by the various “BSD” based operating systems, Linux, etc.) on a per endpoint basis. The AST allows for a large number of endpoints without excessive memory requirements and the optimization and specialization of the socket layer for the needs of a particular application. Examples of creating, customizing, connecting and using an endpoint are described in detail below.

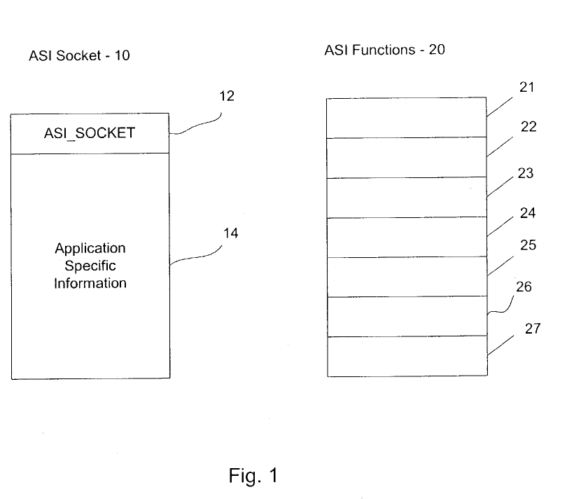

FIG. 1 shows an exemplary data structure 10 for an application specific AST socket object. The application specific AST socket object 10 includes a core ASI_SOCKET structure 12 which may include the information required of all ASI socket objects, and may be considered an object of the base class of all application specific classes of ASI sockets. The fields of the core ASI_SOCKET 12 in the exemplary embodiment may include a pointer to a table of functions 20 required by the protocols to access, query, and manipulate the application specific AST socket object 10. These ASI socket functions 20 provide a standard interface, but are implemented by the application. The exemplary core ASI_SOCKET 12 may also include, but is not required to include, several commonly used fields directly accessible by the protocols for efficiency reasons. The protocols have knowledge only of the core AST_SOCKET structure 12, not of the entire application specific ASI socket object 10 in which the core ASI_SOCKET 12 maybe embedded. An example of a core object (e.g., ASI_SOCKET 12) for a class may be:

ASI_SOCKET :
{

| | | |
|---|---|---|
| [var name] | // | Pointer to application implemented socket class |
| | | member functions; |
| so_state | // | Socket state field; |
| so_options | // | Socket option field; |
| so_PCB | // | Pointer to attached protocol control block (PCB); |
| so_proto | // | Pointer to the protocol object for the protocol in use; |
| } | | |

As can be seen from this example of a core object, the ASI_SOCKET structure 12 may include a pointer to the functions (e.g., ASI socket functions 20) which may be used when this core object is incorporated into the ASI socket object 10. The ASI socket functions 20 (sometimes referred to as callbacks or callback functions) may be used by protocols to request endpoint specific services from the ASI socket object 10. In the example of FIG. 1, the ASI socket object 10 is associated with the endpoint class having ASI functions 20 which include functions 21-27. The protocols that need to access the endpoint services of AST socket object 10, may use any of the functions 21-27 to access these services. The functions may include functions which the stack calls when various protocol events occur for the endpoint, e.g., data is received, data is acknowledged, peer closes connection, etc., and other functions which the protocols call to obtain information on the endpoint, e.g., available space in the receive buffer of the endpoint. Additional exemplary ASI functions will be described below.

In the exemplary embodiment of the present invention, the protocols do not need to know any specific information about the structure of the AST socket object 10, but merely need to access the AST functions 20 associated with the ASI socket object 10 in order to request services and information from the AST socket object 10. Thus, even though the ASI socket object 10 may be customized for a particular application, this customization is transparent to the protocol when accessing the AST socket object 10 because the ASI functions 20 act as a generic interface. As described above, the core object ASI_SOCKET structure 12 embedded within the AST socket object 10 may include the pointer to the ASI functions 20.

The exemplary core object ASI_SOCKET structure 12 may include, for example, frequently used BSD socket members such as so_state, so options, so_pcb, and so_proto. For more information on the functionality of these members refer to “TCP/IP Illustrated, Volume 2: The Implementation,” Wright and Stevens, Addison-Wesely Publishing Company, 1995. The exemplary ASI_SOCKET structure 12 encapsulates a standard socket structure into the core object. This standard socket structure may be used to control basic socket functions. Thus, by incorporating the exemplary ASI_SOCKET structure 12 into the ASI socket object 10, each new ASI socket object 10 created for an endpoint may include the basic socket functionality. The encapsulation of these fields in the ASI socket object 10 alleviates the need for the protocols to know the particular structure of the ASI socket object 10 because the protocol is not directly accessing the ASI socket object 10. Access to the ASI socket object 10 is accomplished via the callback functions, e.g., ASI functions 21-27.

Those of skill in the art will understand that the exemplary core object ASI_SOCKET structure 12 is only exemplary and that different operating systems may use different core objects. It is possible that a single operating system may have multiple core object structures. However, the most general case is that there is a single core object structure (e.g., core object ASI_SOCKET structure 12) for each operating system on a device.

An application developer may create any number of AST endpoint classes from the core object structure (e.g., core object ASI_SOCKET structure 12). The ASI endpoint classes may include any type of functionality and point to any set or subset of ASI functions. The ASI sockets created from the core object structure may differ in the implementation of the callbacks and the form of the derived application specific ASI socket objects (e.g., ASI socket object 10). Thus, each individual socket endpoint may belong to an ASI endpoint class. The implementation of the callbacks (e.g., the ASI socket functions 21-27) for an ASI socket object 10 is determined by the ASI endpoint class to which the ASI socket object 10 belongs. For example, there may be a first ASI endpoint class for stream endpoints, a second ASI endpoint class for datagram endpoints and any number of additional endpoint classes for each type of endpoints. Thus, a particular application (or protocol) may select an ASI endpoint class having the functionality which best suits the needs of the application when the application makes a request to create a new socket. Specializations within ASI endpoint classes may include zero copy endpoint classes, single protocol only (e.g., TCP) endpoints, listening endpoints, etc. The specifics of ASI endpoint classes allow for optimization of the socket code, for example, the socket buffering code. The ASI class may provide a discrete sockets support layer for the application or may be more tightly integrated with the application. The creation of a socket by an application will be described in greater detail below.

Those of skill in the art will understand that the term application as used in this description generally refers to kernel level applications which are generally responsible for the creation and maintenance of sockets. However, the present invention is not limited to kernel level applications creating and using ASI socket objects. The present invention may also be implemented on a system where higher level applications perform such functions.

When an ASI socket object is created (e.g., ASI socket object 10), it may also include application specific information 14. This application specific information 14 may include, for example, nodes for linking the socket into various lists, pointers and byte counts for managing the send and receive socket buffers, lists of child endpoints, an endpoint handle value for communicating about the endpoint with higher level code or a remote agent, semaphores, control flags, an error field, etc. These fields are used by the ASI socket functions 20 which define the endpoint class in order to perform their required functions, and are also used by whatever interface functions the ASI class implementation provides to the higher level portions of the applications.

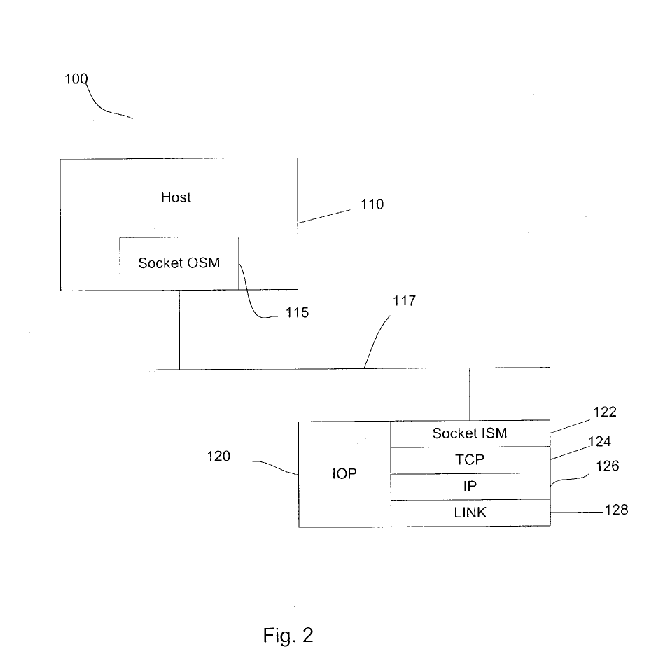

FIG. 2 shows an exemplary system 100 implementing the ASI sockets. The system 100 includes a host processor 110 having a Socket Operating System Module (“OSM”) application 115. The system 100 also includes a secondary I/O processor 120 having a Socket Intermediate Service Module (“ISM”) application 122, a Transmission Control Protocol (“TCP”) layer 124, an Internet Protocol (“IP”) layer 126 and a link layer protocol 128. The host processor 110 and the secondary I/O processor 120 communicate via a bus 117. The Socket OSM 115 may be considered to be a driver portion of the operating system which resides on the host processor 110 and is used to generate socket related messages destined for the secondary I/O processor 120. The host processor 110 and the secondary I/O processor 120 may exchange messages via the Socket OSM 115 and the applications on the secondary I/O processor 120 (e.g., Socket ISM 122). For example, the Socket OSM 115 may generate a message using the I20 standard which is transmitted via bus 117 to the secondary I/O processor 120. In this example, the ASI implementation forms an internal lower layer of the Socket ISM 122, and communicates with the TCP layer 124, the IP layer 126 and the link layer 128. The exemplary system 100 may also support the User Datagram Protocol (“UDP”). A different ASI socket class may be implemented for TCP and UDP endpoints.

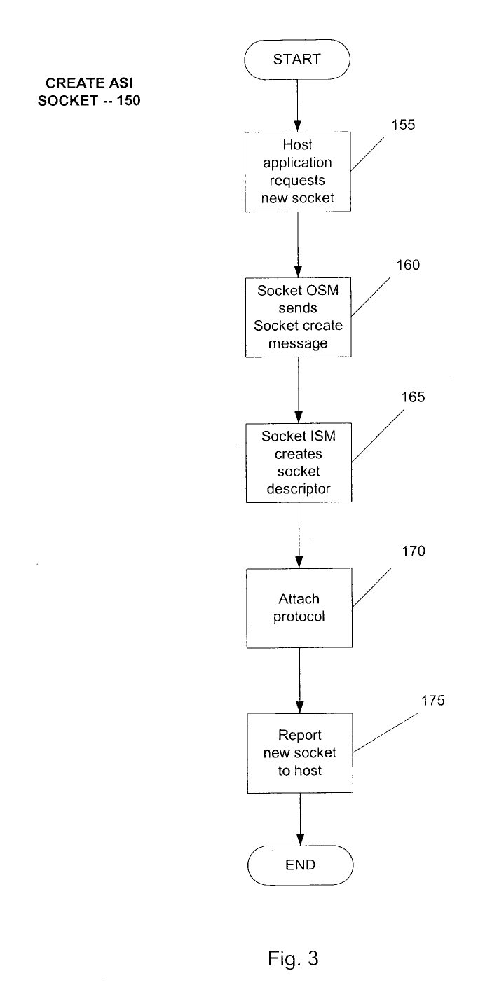

FIG. 3 shows an exemplary process 150 for creating an ASI socket object (e.g., ASI socket object 10 of FIG. 1). The process will be described with reference to the system 100 of FIG. 2. In step 155, the host processor 110 (or more specifically an application residing on host processor 110) desires to create a new ASI socket endpoint and the application relays this request to the Socket OSM 115. In step 160, the Socket OSM application 115 sends a message (e.g., a socket create message) to the Socket ISM 122 of the secondary I/O processor 120. The message may be sent from the Socket OSM 115 to the Socket ISM 122 via the bus 117. For example, the message may be formatted as an I20 sockets class message. The message may include a handle or a name which the Socket OSM 115 may use to identify the requested ASI socket. The handle will allow the Socket OSM 115 and the Socket ISM 122 to exchange messages concerning the ASI socket such that each module 115 and 122 understand the ASI socket being referred to in the messages. The Socket ISM 122 may use the same or a different handle or name to identify the requested ASI socket.

Those of skill in the art will understand that the Socket ISM application 122 is only exemplary and a message may be sent to any ISM application residing on the I/O processor 120. In this particular example, since the message is to create a new socket endpoint, the message will be directed to the Socket ISM application 122. In another example, the ISM application may be an iSCSI ISM. An example using a SCSI ISM will be described in greater detail below.

Continuing with step 165 of FIG. 3, the Socket ISM 122 creates and initializes an instance of its specific ASI socket endpoint descriptor (e.g., AST socket object 10), including the core ASI_SOCKET structure 12, for the new endpoint. Depending on the type of socket and underlying protocol, the Socket ISM 122 selects the table of ASI callback functions (e.g., ASI functions 20) to use for the new endpoint and stores a pointer to that table in the ASI_SOCKET structure 12. The Socket ISM 122 initializes the application specific information 14 of its endpoint descriptor as required. This initialization may be based, at least in part, on parameters that were included in the socket creation message from the Socket OSM 115.

In step 170, the appropriate protocol (e.g., TCP, IP, User Datagram Protocol (“UDP”), etc.) is attached to the socket. The socket layer notifies the appropriate protocol of the existence of the new AST socket endpoint by calling the protocol's appropriate user request function (“PRU”). This results in the protocol attaching its own control data structure, called a protocol control block (“PCB”). to the ASI_SOCKET 12. Typically, a pointer is provided within the ASI_SOCKET 12 for this purpose. Those of skill in the art will understand that PRU functions are a set of functions forming an interface which protocols provide to the sockets layer or to higher level protocols, enabling protocol operations on particular endpoints. For example, there may be PRU functions for attaching the protocol to an endpoint, for sending data for an endpoint via the protocol, for connecting an endpoint to a remote address via the protocol, etc. Each of these PRU functions are associated with the particular protocol and correspond to services provided by the protocol, primarily to the sockets layer. The PRU functions are different from the ASI functions (e.g. AST functions 21-27 of FIG. 1) which implement endpoint-specific services provided by the sockets layer (ASI class) to the protocols.

There may be instances where the protocol in executing a PRU function needs to access the ASI socket object in order to obtain the necessary information to complete the PRU function. Thus, the protocol, when executing the PRU function, may call an AST function to obtain the necessary information. For example, when TCP is sending data from a connected ASI endpoint to its peer, the TCP output routine may need to know the amount of data presently in the endpoint's send socket buffer. In order to set the advertised receive window appropriately in outgoing segments, TCP may need to know how much space is available in the endpoint's receive buffer. For each of these there will be a defined ASI callback function returning the required information. Furthermore, TCP may need a mechanism to obtain the data segments it decides to send from within the endpoint's send buffer.

Continuing with the example, the particular ASI socket object will specify a set of ASI callback functions which may include an exemplary ASI function called sendDataGet( ). This exemplary ASI function may be called by a protocol to obtain a segment of data of a specified length at a specified offset within the ASI socket's send buffer. The data structures implementing the send buffer may be part of the private application specific information 14 in the ASI socket object 10, and the protocol does not know the format or location of this information. Nevertheless, by calling the sendDataGet( ) function, the protocol may obtain a description of the segment that it expects.

Continuing with step 170 of FIG. 3, the protocol is attached to the new socket using a PRU function (e.g., PRU_ATTACH). This function notifies the protocol of the new endpoint. The protocol creates its own data structure (e.g., a PCB) corresponding to the ASI_SOCKET structure 12 passed to it, and links the PCB to the ASI_SOCKET structure 12. As described above, to complete the PRU_ATTACH function, the protocol may need to access some endpoint information initialized by the Socket ISM 122 in step 165. If this information is not present in the ASI_SOCKET structure 12, the protocol uses the ASI functions 20 (FIG. 1) associated with the ASI socket (e.g., ASI Socket 10) to access the fields in the socket description. Thus, the protocol uses these functions to access the application specific information 14 stored in the private section of the ASI socket descriptor 10.

If the protocol attach is successful in step 170, the PRU_ATTACH user request function returns a success result to the Socket ISM 122 which then may report back to the host processor 110 via the bus 117 and the Socket OSM 115 that the new socket is available for use by the host user application (step 175). The message sent from the Socket ISM 122 to the Socket OSM 115 may be, for example, a socket create reply message as defined in the I20 socket message class, and may contain the handle designated by the Socket OSM 115 when sending the message to create the socket. The Socket OSM 115 may use the handle information to report the availability of the new socket to the application which requested the socket be created. When the successful creation of the new socket is reported in step 175, the process 150 is complete. Those of skill in the art will understand that the Socket ISM 122 communication with the Socket OSM 115 and the latter's communication with the host 110 user application are incidental details of this particular illustrative example, and are not part of the Asynchronous Sockets Interface itself.

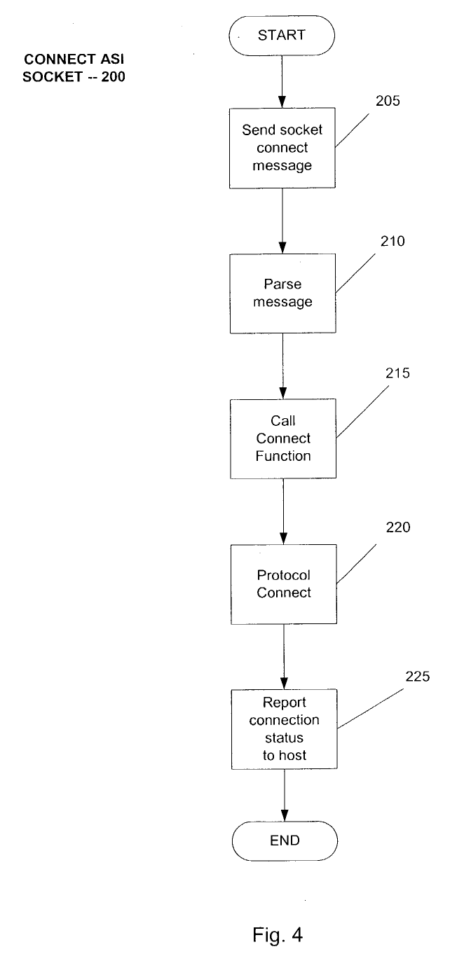

FIG. 4 shows an exemplary process 200 in which an ASI endpoint is connected to a remote peer socket endpoint (which need not be controlled by an ASI application). The process will be described with reference to the exemplary system 100 of FIG. 2. In step 205, when an application on the host 110 wants to use an ASI socket that has previously been created, the host 110, via the Socket OSM 115 and bus 117, sends a message to the Socket ISM 122 on the secondary I/O processor 120. As previously described, the message sent across bus 117 may be in any format, for example, that is defined by the I20 socket message class. The message may contain a variety of information and when the message is received by the Socket ISM 122, the message may be parsed to retrieve all the relevant information in the message (step 210). Those of skill in the art will understand that the parsing step may be optional and generally depends on the message format. In any case, the Socket ISM 122 receives and decodes the message which contains the information as to which ASI socket is to be connected and other information, for example, the remote address to which the ASI socket should be connected.

In step 215, the Socket ISM 122 calls its internal connect function for the ASI endpoint using the information contained in the message. The connect function does any work specific to the Socket ISM 122 which may be needed to manage the connection attempt, and then calls the underlying protocol's connect user request function (e.g., PRU_CONNECT) (step 220). For some protocols (e.g., UDP), making the “connection” does not actually involve communication with a network peer, and these protocols may report the endpoint connected immediately. Other protocols (e.g., TCP) must exchange a sequence of hand shaking packets with the network peer to establish the connection. In this case, the PRU_CONNECT function also returns immediately indicating a successful initiation of the connection attempt (i.e., the endpoint is connecting, but not yet connected). The protocol will later call an appropriate ASI function for the endpoint when the connection attempt succeeds, times out, or fails to connect for some other reason. In this sense, the ASI is an asynchronous interface because rather than blocking waiting for completion of operations depending on external events (e.g., peer responses or time-outs), the ASI calls a protocol function to initiate the operation, and the protocol later calls back an ASI function to indicate the completion of (or progress in) the operation.

If the protocol successfully connects to the remote address, the protocol reports the connection to the ASI socket by calling an ASI function which indicates that the ASI socket is successfully connected to its peer. For example, the ASI socket object may have an associated ASI function called isConnected( ). The protocol may call the isConnected( ) function when the PRU connect function is successfully completed. The call to the isConnected( ) function by the protocol indicates to the endpoint that the requested connection has been successfully completed. The ASI socket may then report the successful connection to the Socket ISM 122 which, in turn, sends a message via the bus 117 and the Socket OSM 115 to the host 110 that the requested connection is established (step 225). The message may contain the ASI socket handle used by the Socket OSM 115 to identify the endpoint and its corresponding application. The endpoint may then be used to send and receive data.

Alternatively, if the protocol connection attempt times out, is rejected, or otherwise fails, a distinct ASI callback function, e.g., isDisconnected( ), may be called. This function may pass the reason for the failure as one of its parameters. In this case, the Socket ISM 122 notifies the Socket OSM 115 of the failure, and the Socket OSM 115 notifies the host 110 application. Those of skill in the art will understand that the steps 220 and 225 of the exemplary process 200 may occur at a later time than the other steps in the process. The delay may be in response, for example, to network events or timeouts.

Those of skill in the art will understand that by implementing ASI sockets according to the present invention, it may be possible to limit the number of threads for the application (e.g., Socket ISM 122) receiving notifications of stack and endpoint events. It may be possible that a single thread may receive all notifications of stack and endpoint events. The elimination of per endpoint threads improves scalability by removing the memory expense of the thread stacks and control blocks and it also decreases the amount of context or task switching. In addition, the ability to specialize the socket layer code to the needs of both the particular application and the particular protocol used may permit performance improvements over a general purpose socket layer implementation.

The following is an example of data being received by the ASI socket and will be described with reference to FIG. 2. The protocol receives data from the peer connection. The protocol then calls an ASI function (e.g., recvData( ) function) to pass the newly received data to the ASI socket. The recvData( ) function may cause the received data to be passed to the receive buffer of the ASI socket. Similar to all the other interaction between the protocol and the ASI socket, the protocol does not directly access the ASI socket receive buffer, but rather calls the recvData( ) function to enqueue the received data. The recvData( ) function implemented by the Socket ISM 122 may then initiate DMA of the received data into kernel buffers in the memory of host 110, and schedule notifications to the Socket OSM 115 of the delivered data when the DMA completes. The local buffers on the secondary I/O processor 120 containing the received data may also be freed at this time. Those of skill int art will understand that the receive buffer need not be a simple contiguous buffer, and in performant systems, the received data may not be copies into the receive buffer.

Upon receiving notification from the Socket ISM 122 of received data available for a host application endpoint, the Socket OSM 115 will enqueue the kernel buffers containing the data in the host 110 side receive queue for that endpoint. When the host application owning the endpoint makes a receive call (e.g., a BSD sockets recv( ) call), received data will be transferred to the application's receive buffer. At this time some of the kernel buffers in the endpoint's host 115 side receive queue may be freed. The Socket OSM 115 may select to make these available to the Socket ISM 122 for further received data on the same or other endpoints. Again, note that the interaction of the Socket ISM 122 with the Socket OSM 115 and the latter with the host application, are incidental to the ASI interface, which relates exclusively to the interaction of the Socket ISM 122 with the protocol layers of the network stack on the I/O processor 120.

The above description used the example of a Socket OSM 115 and a Socket ISM 122 in a host processor/secondary processor system. This implementation is only exemplary. There may be any number of other implementations according to the present invention. For example, iSCSI initiator software running on an iSCSI host board adapter may use the ASI interface to communicate with the underlying TCP protocol and manage the connections making up iSCSI sessions. In this case, the iSCSI software's ASI layer may not need to support UDP endpoints, as iSCSI connections are exclusively TCP. In addition, the present invention may be implemented in a single processor environment (in which case the Socket OSM 115 and the Socket ISM 122 may not be needed).

The above description included several examples of ASI functions, e.g., recvData( ), isConnected( ), etc and PRU functions e.g., PRU_SEND, PRU_ATTACH, etc. Those of skill in the art will understand that these function are only exemplary and that the exact number and type of included functions will depend on the detailed implementation of the network stack for the operating system to which the ASI functionality is added.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A socket object, comprising:
application specific information configured to allow interaction with an application; and
a core object having data for a specific class corresponding to the socket object, the data including a pointer to a set of functions corresponding to the class, wherein a protocol is limited to knowledge of the core object and uses the set of functions to obtain access to the application specific information.

2. The socket object according to claim 1, wherein the core object further includes a field directly accessible by the protocol.

3. The socket object according to claim 1, wherein the core object corresponds to an operating system.

4. The socket object according to claim 1, wherein the class is one of a streaming endpoint class and a datagram endpoint class.

5. The socket object according to claim 1, wherein the application specific information includes one of nodes for linking the socket object into various lists, byte counts for managing send and receive socket buffers, lists of child endpoints, an endpoint handle value for communicating with higher level code, semaphores, control flags, and an error field.

6. A system, comprising:
an application;
a protocol to communicate data over a computer network; and
a sockets layer providing an endpoint service to the application and the protocol, the sockets layer including an endpoint class, the sockets layer configured to create an endpoint to provide the endpoint service, the endpoint including a pointer to a set of functions corresponding to the endpoint class and information corresponding to the application.

7. The system according to claim 6, wherein, when the sockets layer creates the endpoint, the sockets layer notifies the protocol of the endpoint and the protocol attaches a control data structure to the endpoint.

8. The system according to claim 6, wherein the protocol is one of a Transmission Control Protocol, an Internet Protocol and a User Datagram Protocol.

9. The system according to claim 6, wherein the protocol accesses the information corresponding to the application via the set of functions.

10. The system according to claim 6, wherein the application resides on a host processor.

11. The system according to claim 6, wherein the protocol resides on an I/O processor.

12. A method, comprising the steps of:
receiving data at a protocol;
accessing a function corresponding to an endpoint, the function causing the data to be passed to a receive buffer of the endpoint;
copying the data to a kernel buffer for the endpoint; and
freeing the receive buffer of the endpoint.

13. The method of 12, further comprising the steps of:
copying the data to an application receive buffer; and
freeing the kernel buffer for the endpoint.

14. The method of claim 12, wherein the endpoint includes information corresponding to the application and a pointer to a set of functions corresponding to an endpoint class.

15. The method of claim 14, wherein the function is included in the set of functions.
